(19) United States
(12) Patent Application Publication
(10) Pub. No.: US 2010/0306787 A1
(43) Pub. Date: Dec. 2, 2010

(54) Enhancing Service Reuse Through Extraction of Service Environments

(75) Inventors: Kalapriya Kannan, Bangalore (IN); Lakshmish M. Ramaswamy, Lawrenceville, GA (US); Soudip RoyChowdhury, Birati (IN)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 12/474,427

(22) Filed: May 29, 2009

(51) Int. Cl. G06F 9/44

(52) U.S. Cl. 719/315

(57) ABSTRACT

For each of a plurality of existing services of a service-oriented architecture, a corresponding environment is defined. Information representative of the defined corresponding environments is stored together with descriptions of the existing services. At least two of the existing services are composed to provide new functionality, based upon the descriptions of the at least two existing services and the information representative of the defined corresponding environments for the at least two existing services.

### FIELD OF THE INVENTION

The present invention relates to the electrical, electronic and computer arts, and, more particularly, to service-oriented architecture and the like.

### BACKGROUND OF THE INVENTION

A service-oriented architecture (SOA) employs interoperable services. A SOA infrastructure permits data exchange between different applications. Functions may be separated into distinct units, or services, which developers make accessible over a network for the production of applications. Service descriptions have previously taken many forms. Naming identifies capabilities with a symbolic token such as a name (uniform resource locator (URL) and the like). Interfaces are also used as service descriptions, as in the case of the “Jini” service-oriented architecture (www dot jini dot org). More refined functional information has been used for service descriptions as well, such as valid operation sequences (as in Web Services Conversation Language (WSCL)) or pre- or post-conditions as in the OWL-S semantic markup for web services (formerly DAML-S). Two contexts in which this may be useful include service discovery and services matching (services similarity).

Industry standards such as Web Services Description Language (WSDL) and OWL-S describe a service as a collection of operations, where an operation is defined by its signature (that is, operation name, input and output parameter names and types). In this setting, two services are considered to match if their operations match; and two operations match if their names, input and output parameters match. Several techniques have been used to find out if two services are similar based on the description. They rely on the information exposed by the service to determine the similarity. Methods such as resolving semantic, syntactic and structural differences among the interfaces have been proposed in the literature.

### SUMMARY OF THE INVENTION

Principles of the invention provide techniques for enhancing service reuse through extraction of service environments and defining them along with service descriptions. In one aspect, an exemplary method (which can be computer-implemented) includes the step of, for each of a plurality of existing services of a service-oriented architecture, defining a corresponding environment. An additional step includes storing information representative of the defined corresponding environments together with descriptions of the existing services. The method further includes composing at least two of the existing services to provide new functionality, based upon the descriptions of the at least two existing services and the information representative of the defined corresponding environments for the at least two existing services.

One or more embodiments of the invention or elements thereof can be implemented in the form of a computer product including a tangible computer readable recordable storage medium with computer usable program code for performing the method steps indicated. Furthermore, one or more embodiments of the invention or elements thereof can be implemented in the form of an apparatus including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s), or (iii) a combination of hardware and software modules; any of (i)-(iii) implement the specific techniques set forth herein, and the software modules are stored in a tangible computer-readable recordable storage medium (or multiple such media).

One or more embodiments of the invention may offer one or more of the following technical benefits:
effective mapping of service requirements with the endpoint implementation
effective exposure of the behavior of the service that helps in better definition of the existence of the service.

These and other features, aspects and advantages of the invention will become apparent from the following detailed description of illustrative embodiments thereof, which is to be read in connection with the accompanying drawings.

### BRIEF DESCRIPTION OF THE DRAWINGS

FIG. 1 presents an example of environmental modeling to enrich service description, according to an aspect of the invention;

FIG. 2 illustrates exemplary importance of environmental artifacts in the form of domain information;

FIG. 3 illustrates exemplary importance of environmental artifacts in the form of events;

FIG. 4 illustrates exemplary importance of environmental artifacts in the form of entities and data domains;

FIG. 5 illustrates availability of information about external events, external entities, and/or domain information in design diagrams;

FIG. 6 presents an example of domain knowledge extraction, according to another aspect of the invention;

FIG. 7 presents an example pertinent to event extraction;

FIG. 8 depicts event extraction from a sequence diagram, according to still another aspect of the invention;

FIG. 9 presents a non-limiting example, pertaining to course registration;

FIG. 10 presents portions of FIG. 9 on a larger scale;

FIG. 11 continues the student registration example;

FIG. 12 is a block diagram of an exemplary software architecture, according to another aspect of the invention;

FIG. 13 is a flow chart of exemplary method steps, according to yet another aspect of the invention; and

FIG. 14 depicts a computer system that may be useful in implementing one or more aspects and/or elements of the invention.

### DETAILED DESCRIPTION

One or more embodiments of the invention extract all software artifacts from the low level diagram such as sequence diagram, business models, and/or business processes that directly or indirectly influence the definition and existence by adding to behavioral definition of the services.

Services typically do not exist as individual components, but rather, they form eco-systems. In one or more embodiments of the invention, service descriptions are augmented with service environmental information to enhance service identification and the services similarity matching problem. Adding semantics and/or Independent Operational Evaluation Plan (IOEP) similarity matching techniques are useful but they are not sufficient to identify the candidate services as they do not expose any functional aspect of the service. Embodiments of the invention define an environment for the service and also provide a methodology for extracting the environmental information from the design diagrams and therefore enhance the service descriptions.

Service descriptions form the limiting factor for similarity measures of the services. One or more embodiments advantageously provide and enhance service descriptions without exposing the internals of the service such that (a) better recall and precision can be obtained when discovering services and (b) the similarity measure can be increased when comparing services. A limiting case is encountered when the complete internal details of the service are available.

Event-driven architecture (EDA) promotes the production, detection, consumption of, and reaction to events, and can complement SOA. Services can be activated in response to incoming events. Complex event processing (CEP) analyzes patterns of simple and ordinary events to infer occurrence of a complex event. Events are thus of importance within the SOA field.

As noted above, service descriptions have previously taken many forms. Services preferably do not expose the internal methodology through which they implement required functions. Furthermore, since, as noted, services typically do not exist as independent entities (they interact with other services and form an eco-system), their external interaction and their environment is important in describing them. As used herein, “environment” can include one, some, or all external factors in the eco-system. One or more embodiments focus on select external factors such as events (those that are responsible for invoking the service, for example, via an assertion, a function call, or data flow, and the like); the roles of people and/or actors (interaction with the outside entities); and domain (the broader scope, that is, taxonomy of the service). There can be several other factors that can be part of the environment. One or more embodiments of the invention provide a method for extracting this information from the unified modeling language (UML) (or similar) diagrams that typically an integral part of development projects.

The functionality of a service can be exposed by exposing the behavior (through models) of the function; however, this in essence violates the basic definition of a service (providing abstraction without exposing the internal details). One or more embodiments of the invention define the behavior of the service by capturing the condition(s) under which the service can be invoked. This can be done by capturing the low level functional (design) “Environmental Artifacts” of the service in environmental models and exposing this along with the service descriptions.

As used herein, “Environmental Artifacts” mean any artifact related to service invocation. Such “Environmental Artifacts” may be captured in three forms:
(a) domain to which the service belongs,
(b) external inputs that directly result in service invocation such as events, and
(c) external factors that invoke the service such as actors/roles of actors.

Structural or “behavioral” information of the service (essentially of its operations) is widely used for service descriptions. Semantic information on the names and the like has been used for further enhancing the meaning of the services. Context (often an overloaded term) has also been used to induce semantics (especially in pervasive computing systems); for instance, in a location based manner, wherein location, capabilities (such as what the service does), features of the services, and the like, are described to facilitate the search. Each of these aspects has its own limitations, utilization effects, and required input(s). In at least some instances, structural and semantic descriptions of the interface signature may have certain drawbacks. For example, either it is assumed that the names of the services are known a priori, or the names are equipped with information to add semantic information. Even if the names semantically match with each other, the services might be entirely different in the functionality they provide.

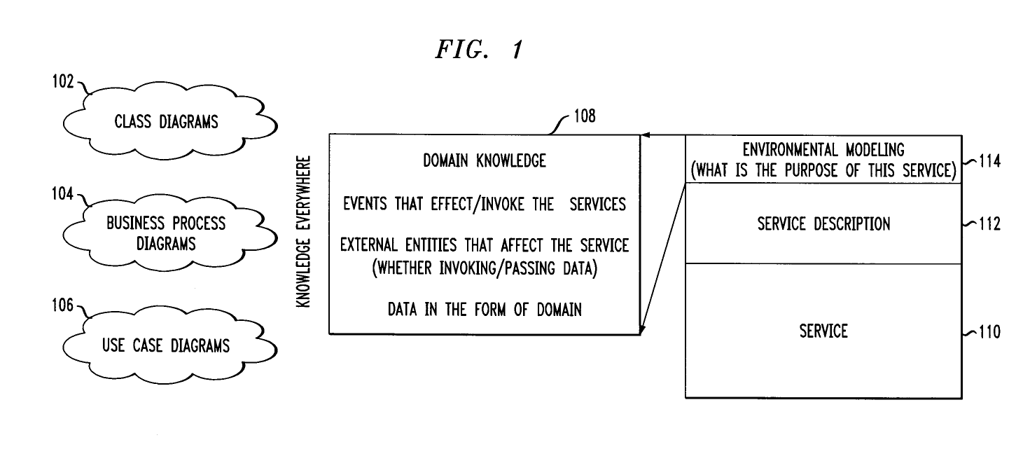

Reference should now be had to FIG. 1. Service 110 has an associated service description 112 and environmental modeling 114. The latter essentially describes the purpose of the service. As indicated at 108, environmental modeling may include, for example, one or more of domain knowledge, events that impact and/or invoke the services, external entities that impact the service (whether invoking and/or passing data), data in the form of domain (that represents the domain information of the service), events that expose the behavioral functionality, events that invoke that service, actors who use the service, and the like. Knowledge may be gleaned from a variety of locations; for example, class diagrams 102, business process diagrams 104, and/or use case diagrams 106. As used herein, the term “enterprise” is understood to broadly refer to any entity that is created or formed to achieve some purpose, examples of which include, but are not limited to, an understanding, an endeavor, a venture, a business, a concern, a corporation, an establishment, a firm, an organization, or the like. Thus, “enterprise processes” are processes that the enterprise performs in the course of attempting to achieve that purpose. By way of one example only, enterprise processes may comprise business processes.

The domain to which the service 110 belongs is quite significant, since reuse is more favorable in the same domain. It is important, in at least some instances, to explicitly announce the domain in which a service is more functional. Cross-domain interoperability is typically less (but it is nevertheless desirable to explore same, in at least some embodiments). Events indicate under what conditions the service can be invoked or reflect the context in which the service can be invoked. Entities list the people (and/or machines) (precisely the actors) who use the service. Input and output of data is preferably at the level of the service and not at the level of types.

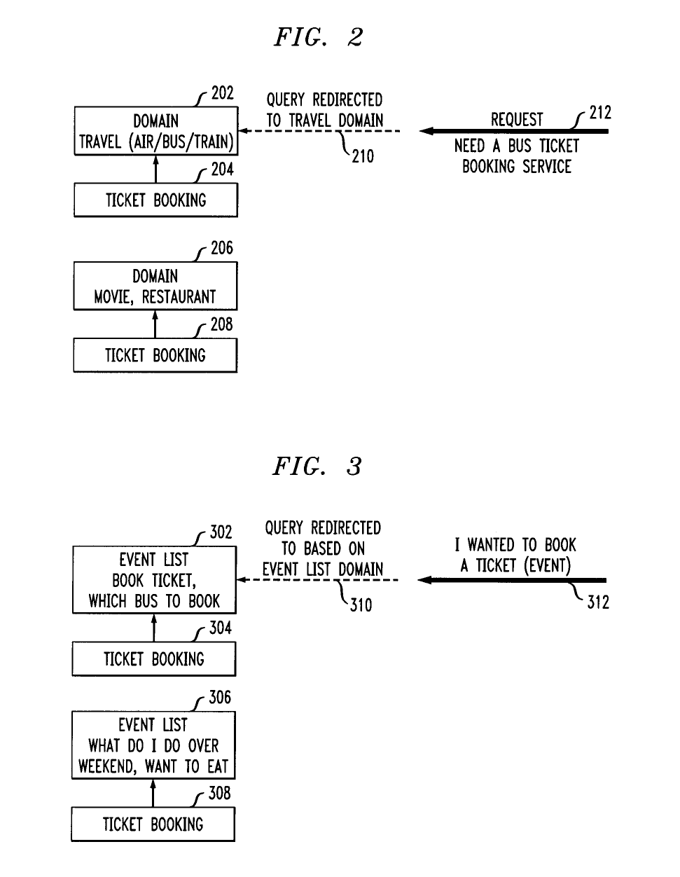

In one or more embodiments, as illustrated in FIG. 2, domain information helps in two ways. On the discovery front, it narrows the discovery to a specific domain. The domain of the functionality is quite significant information as it determines whether the two functions are relevant in a given context. For example, authentication in a banking domain is different than authentication in a retail domain and both might have different functionalities attached with each other. Therefore, if the domains match for two services, then it clears one level of match as to whether they semantically match the functional domain. Thus, request 212 is received indicating a need for a bus ticket booking service. Ticket booking might pertain to the domain of movies and restaurants, as at 208, 206, but might also pertain to the domain of travel by air, bus, and or train, as at 204, 202. Thus, in the example, the service is ticket booking while the domain is travel, with redirection to 202 as indicated at 210.

In one or more embodiments, as illustrated in FIG. 3, events play an important role in one or more of the following ways: On the discovery front, events can be specified to identify the services that can be invoked when these events happen, or the kind of services that will produce these kinds of events. If the events lists match for two services, then this probably implies that the two services can be invoked under the same set of conditions. Thus, request 312 is received indicating a desire to book an event ticket. Ticket booking might pertain to the event list domain of what to eat or do over the weekend, as at 308, 306, but might also pertain to the domain of booking tickets, or which bus to book, as at 304, 302. Thus, in the example, the query is redirected to 302 based on the event list domain, as indicated at 310.

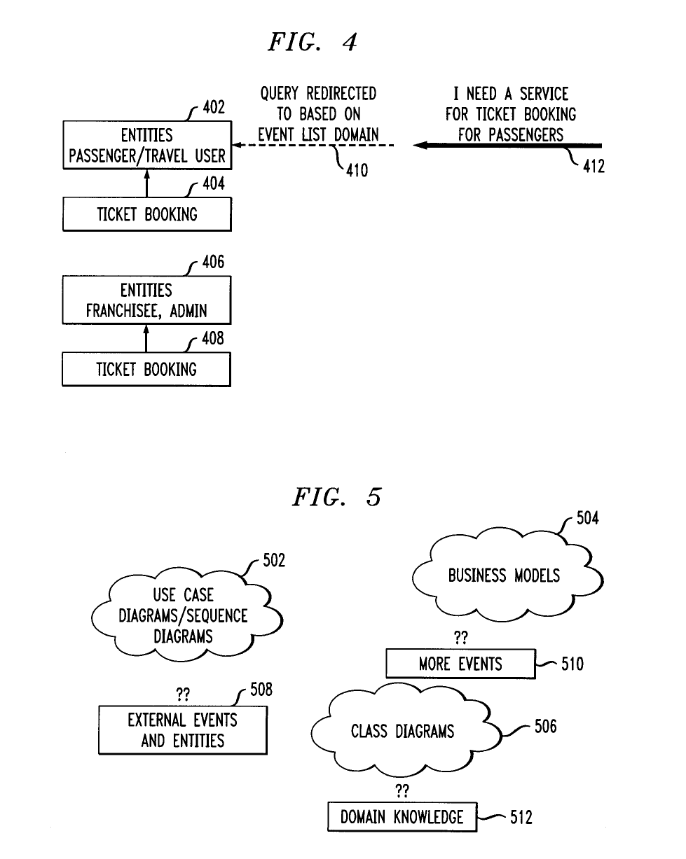

In at least some instances, with reference to FIG. 4, entities and data domains (assertions and/or data inputs) play an important role in the following ways. On the discovery front, entities are those that require and consume services. Entities, based on their roles, can be used to identify whether the service is identified for the right set of people. When two services should be matched, such matching can be carried out against the set of entities, to check if the entities that require this are same. Thus, request 412 is received indicating a desire for a service for ticket booking for passengers. Ticket booking might pertain to the event list domain of entities including franchisees or administrators, as at 408, 406, but might also pertain to the entities of passengers or other travel users, as at 404, 402. Thus, in the example, the query is redirected to 402 based on the event list domain, as indicated at 410.

As shown in FIG. 5, desired information about external events and/or external entities 508, domain knowledge 512, and additional events 510 is available in the design diagrams such as use case and/or sequence diagrams 502, class diagrams 506, and/or business (or other enterprise) models 504. Thus, information can be obtained, for example, using a suitable extraction technique from the design diagrams, associating them with the service descriptions. The extraction technique takes the sequence diagram as input and retrieves all the messages, such as events, input parameters, and the like that are passed from the actor to invoke the functionality. From existing design diagrams, the knowledge can be reused (but greater effort may be required in such a case to associate them to the right services).

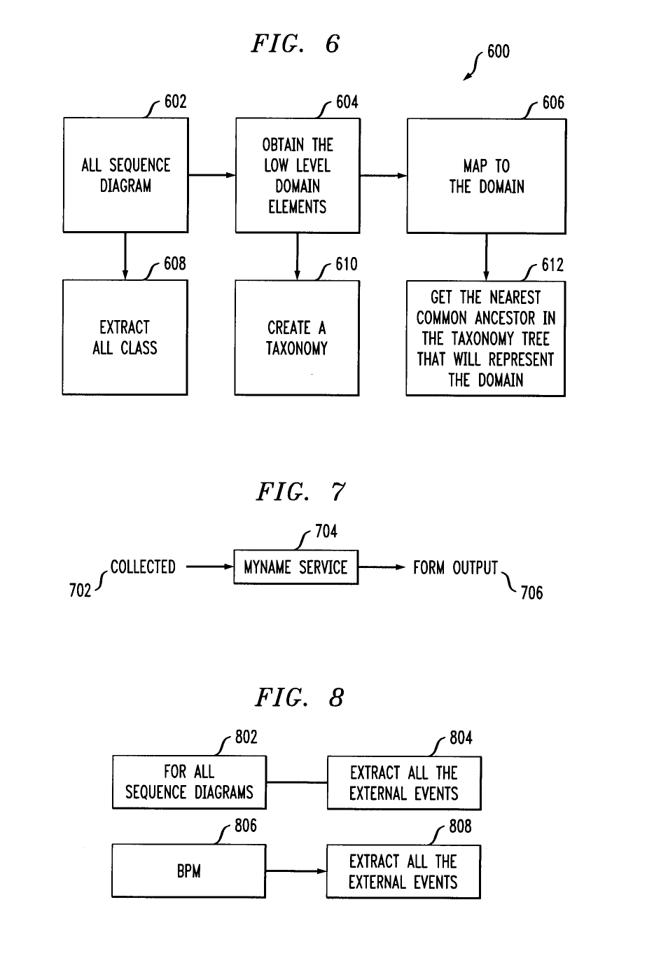

With reference to flow chart 600 of FIG. 6, federation of information from multiple sources can be conducted, for example, via domain knowledge extraction. Consider all sequence diagrams in block 602. Extract all classes therefrom, as per block 608. Obtain the low level domain elements in block 604, use same to create a taxonomy in block 610, and map the low level domain elements to the domain in block 606. In block 612, get the nearest common ancestor in the taxonomy tree that will represent the domain.

Further exemplary details will be provided with respect to event extraction, in connection with FIG. 7. Events are of different forms. Some events do not represent the domain functionality. For example, “collected” 702 is an event that triggers the service and/or causes the service (here, “Myname” service 704) to be invoked, but “collected” as such does not represent the domain information. Output is formed at 706. Some events do represent the domain functionality that is actually associated with the service. In one or more embodiments, obtain this information from the sequence diagram. External events are those events from the boundary classes that invoke the entire functionality. Capture them as events. As shown in FIG. 8, with respect to event extraction from a sequence diagram, for all sequence diagrams 802, extract all the external events as in step 804. As indicated, events external to a service can also be obtained using business process management (BPM) 806, from which all the external events are extracted, as in step 808. Business process models are those that model the processes associated in achieving the corresponding functionality. They act as a flow chart for execution of a corresponding functionality and also define the criteria for invoking specific events within the execution chart. For each invocation of a service functionality, there are events and these events can be extracted by a technique that reads the BPM and then picks up the events.

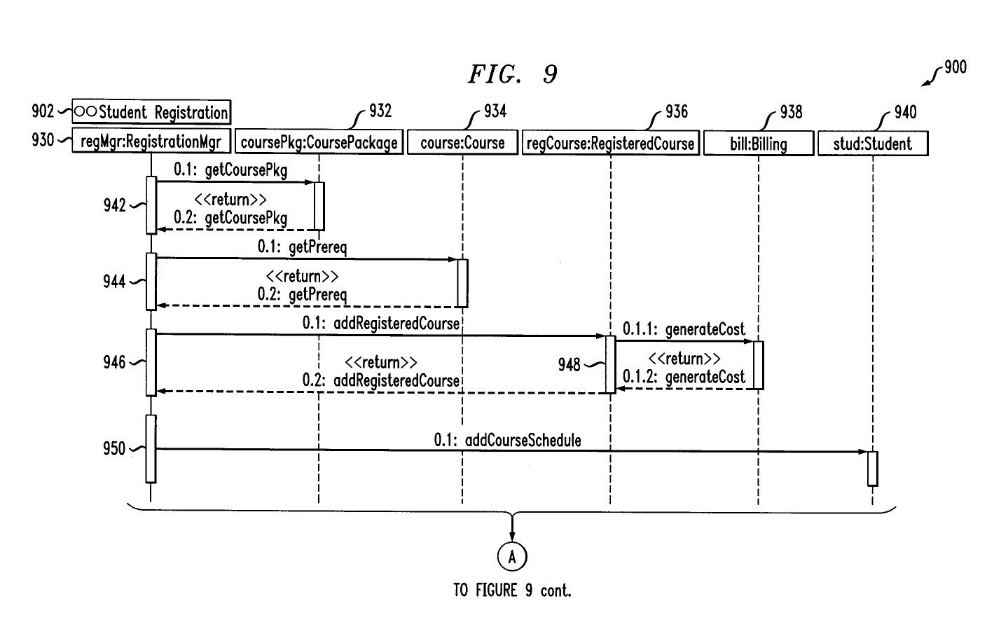

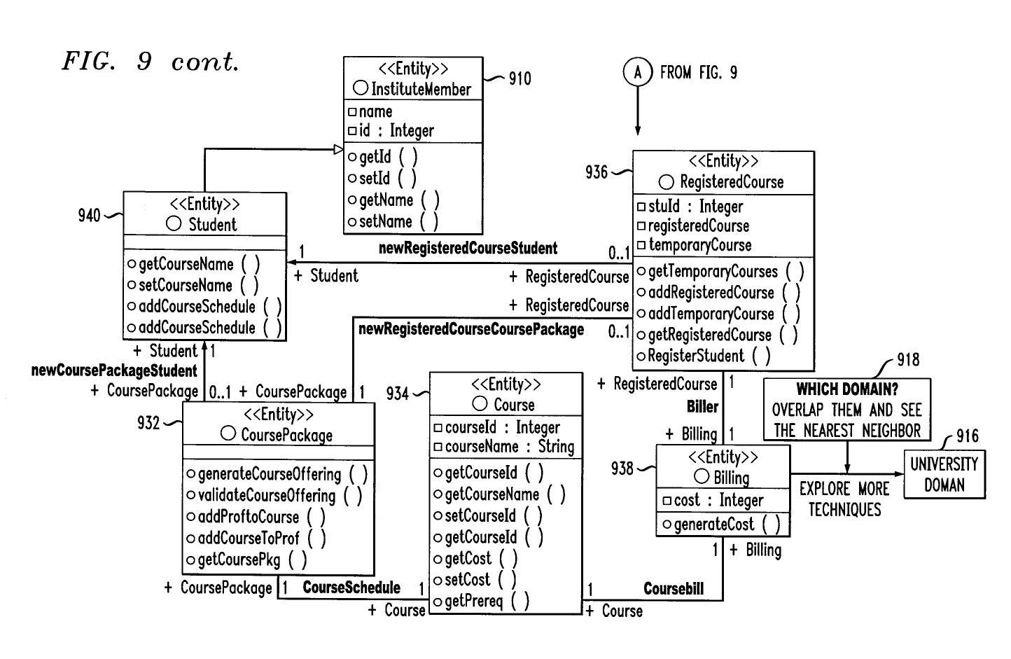

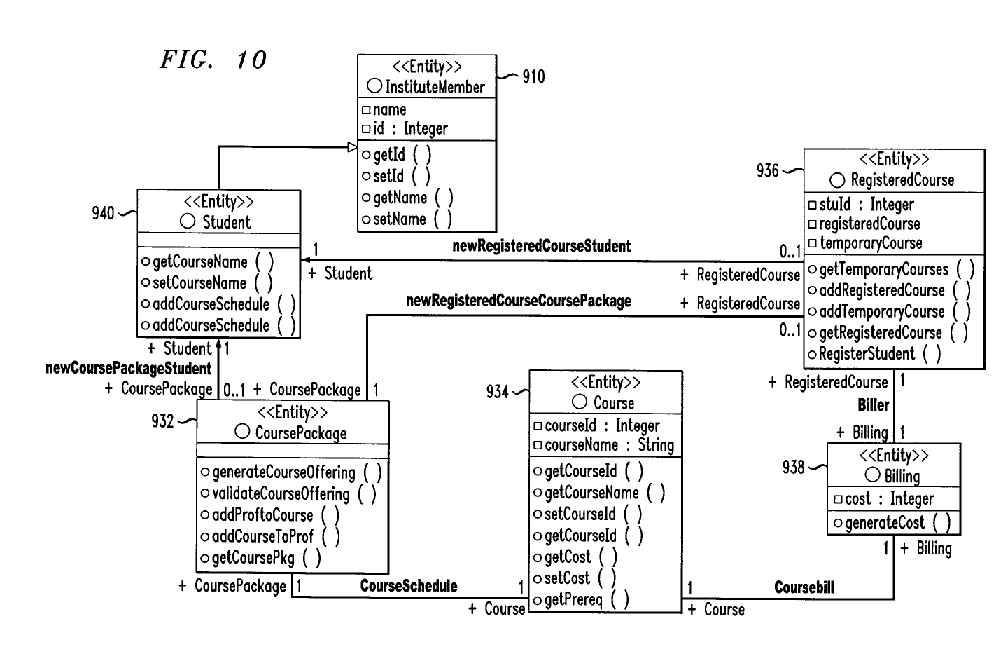

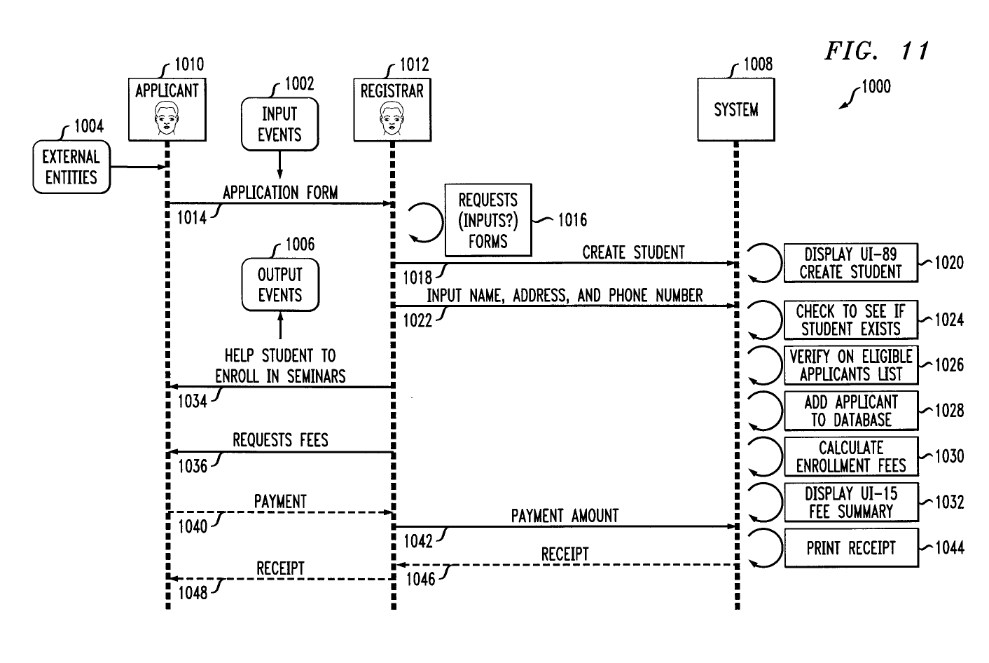

FIGS. 9 and 10 present an example in the context of a sequence diagram for services, in this case, student registration for a course. FIG. 10 merely reproduces the lower left hand portion of FIG. 9 at a larger scale. Diagram 900, as indicated at 902, is directed to student registration. Included are registration manager 930, course package 932, course 934, registered course 936, billing 938, and student 940. Elements 930-940 are classes (generically referred to as software entities and/or artifacts) that help in achieving the functionality of the registration. Note also institute member 910. At 942, registration manager 930 sends a get course package request to course package block 932, and the course package is returned. At 944, registration manager 930 sends a get prerequisites request to course block 934, and the course prerequisites are returned. At 946, registration manager 930 sends an add registered course request to registered course block 936, and the same is returned after registered course block 936 sends a generate cost request to billing block 938, as at 948, and receives the response to same. At 950, registration manager 930 adds the course to the schedule of student 940. To determine the domain, overlap the class diagram after removing the implementation artifacts (boundary, controller classes) as indicated at 918, and the ontology that is available from various search engines. The overlap will be maximum for a set that represents the closest to the class diagram. The root of this tree that is closest to the class diagram will provide the domain information. Then explore more techniques, and conclude that the domain is the university domain 916.

FIG. 11 continues the student registration example, including a chart 1000 with external entities 1004, input events 1002, output events 1006, system 1008, applicant 1010, and registrar 1012. Applicant 1010 sends application form to registrar 1012, as per 1014. Registrar 1012 requests the form at 1016. The registrar requests further information from the student regarding registration to the course such his name, address and phone number. Registrar then requests system 1008 to create a student record as at 1018, and the system responds by displaying user interface “89” for student record creation, as per 1020. The registrar responds at 1022 with the name, address, and phone number, and the system checks to see whether the student exists at 1024, verifies that the student is on the list of eligible applicants at 1026, and adds the applicant to the database at 1028. The system also calculates the enrollment fees at 1030 and displays user interface “15” (a fee summary) at 1032. Meanwhile, registrar 1012 helps student 1010 to enroll in seminars at 1034 and requests the appropriate fees at 1036. Payment is received from the student at 1040, and forwarded to the system at 1042. This in turn results in the system 1008 printing a receipt at 1044, forwarding same to the registrar 1012 at 1046, and the registrar providing same to the applicant 1010 at 1048. All of the above information such as the messages exchanged, the inputs and outputs to each of these messages, the events/functions that invoke such a service are stored as service descriptions.

### Example

By way of a non-limiting example, consider applicability of one or more techniques of the invention to an existing architecture scenario with IBM® WebSphere Business Services Fabric (WBSF) software for adapting and rapidly responding to change with dynamic, SOA-based business processes (registered mark of International Business Machines Corporation, Armonk, N.Y., USA). Such software enables business users to rapidly assemble new business processes and make concurrent changes with governance but minimal impact to IT, while reusing and sharing current IT assets. Similar types of software from other sources could be used. Suppose Bank ABC has purchased the “banking content pack with core WBSF stack. They write the policies (assertion rules) for different business cases and store them in the business repository of WBSF. Depending upon these policies, a dynamic assembler picks up the endpoints which cater the business requirements and maps them with the corresponding business processes. This mapping is done in a manner wherein the point of variability is implemented in the endpoint interface, and in the assertion rules, those conditions are mentioned. Thus, the dynamic assembler picks up the suitable endpoint for a particular scenario at runtime by mapping the endpoint capability (specified in WSDL) with the requirements as specified in the policies. This approach can be sub-optimal in case there is more than one endpoint present for a particular business process.

Suppose Bank ABC has acquired bank XYZ. Bank ABC and Bank XYZ are having an end point Credit Check, which interacts with a back end system to fetch information regarding how much the customer has in his or her account. The business policy for the new transaction is as follows. If XYZ's customers want to make an account transaction, the process flow would involve, first, calling XYZ's credit check function, which in turn will call Bank ABC's credit check functions and then proceed. Both the implementation of the credit check service by ABC and the implementation by XYZ have the same signature and input/output value(s) and both are present in ABC's service repository. At runtime, a dynamic assembler would fail to do the conflict resolution as to “which endpoints are to be picked up when” to map the process with the appropriate endpoint for the credit check process. To address this issue, at design time, hardcode the association of policies and endpoints to solve the problem.

It is to be emphasized that the preceding example is non-limiting, and one or more embodiments of the invention can be employed in many different situations. It should also be noted that one or more embodiments of the invention may useful in a business or other enterprise. However, this does not imply that the claims herein are directed to a method of doing business.

In one or more embodiments, additional information is added in the service description to better perform the mapping. In another sense, one or more aspects of the invention help a dynamic assembler to map the endpoints with the process efficiently at runtime. Advantageously, one or more embodiments of the invention provide a good approach of mapping service requirements with the endpoint implementation. Further, one or more embodiments of the invention help to resolve conflicts and/or to find the best candidate endpoint in case of a tie among endpoints, as compared to techniques which function by relative rating of endpoints and then selecting them in round-robin fashion.

It should be noted that one or more embodiments of the invention include as inputs some or all available inputs having semantic information about an existing service or services, and are not limited to only class and sequence diagrams as inputs.

Note that, in one or more embodiments, the precondition statement indicates what must be true before the function is called, while the post-condition statement indicates what will be true when the function finishes its work. The pre- and the post-conditions are employed, for example, to express the requirements. Service descriptions add metadata for the services. The metadata can be anything ranging from simple classification to expression of intention of the service. While the metadata that is added in one or more embodiments of the invention aids in expressing the intention of the service, the precondition expresses the requirements of the services before invocation. Pre and/or post conditions are on the variables and/or parameters, while one or more embodiments of the invention take into account several aspects, including but not limited to the domain to which the service belongs, environmental variables, roles and/or users, which other services can invoke the given service, and the like.

Pre and/or post conditions are deterministic logical conditions on the variables and/or parameters, whereas in one or more embodiments of the invention, enhancing service descriptions supports characterization of a service through its probabilistic behavior. One possible method to characterize a service is the frequency with which it interacts with and/or is invoked by other services. For example, Service A can be characterized as interacting with another Service B 80% of the time and with Service C 20% of the time. Some aspects of the invention thus make use of information beyond pre and/or post conditions.

Composing existing services to deliver new functionality is a difficult problem as it involves resolving semantic, syntactical and structural differences among the interfaces of a large number of services. One or more embodiments of the invention provide service description(s) that significantly ease service composition for creating new functionalities. Aspects of the invention address well connected semantic information by applying various analytical methods on the different inputs considered. In one or more embodiments, various techniques are used for adding semantic information to the existing services. Information from documents, diagrams, and/or assets used during the process of developing projects is advantageously used, in one or more embodiments, to obtain the semantics of the services. At least some aspects of the invention provide techniques for extracting the environmental information from a design diagram of a service for enhanced mapping of service requirements, and/or use the role of actors and/or entities as the environmental information.

Certain aspects of the invention involve extracting knowledge about service descriptions from the existing repository of knowledge, which typically is in the form of design diagrams, documents, and/or artifacts, and the like. In at least some instances, the context can be entirely different than the service descriptions. Service descriptions may have broader meaning, define the invoking criteria, and include context under reasonable circumstances. Aspects of the invention address extraction of context information. Embodiments of the invention employ service descriptions which include information such as people who are using the services, roles which can act on the service, the callee-caller types, and the like. Some aspects of the invention pertain to how the context is actually obtained; for example, via extraction or mining the wealth of service description knowledge from the existing software project artifacts.

One or more embodiments of the invention extract the knowledge about the environment under which the service can be invoked, which includes spatial-temporal context information of the service invocation, which is derived from the existing artifacts like design documents and the like. One or more instances of the invention address extraction of information (about the environment under which the service can be invoked) from artifacts such as design diagrams, documents, and/or artifacts. Furthermore, one or more embodiments extract the information about the objects and their interrelationship from the relevant artifacts.

Yet further, one or more aspects of the invention address how to extract non-functional information or and how to construct a data pool upon which the matching depends. Indeed, one or more embodiments provide techniques in which assets like design diagrams and the like can be used as a data source, with sufficient intelligence to extract the relevant information regarding the service environment which also includes post- and pre-conditions. In one or more embodiments, there is particular focus on extracting information such as people who are using the services, roles which can act on the service, the callee-caller types, and the like. Thus, in at least some instances, extract environment information under which the service is invoked from the design diagram and the like.

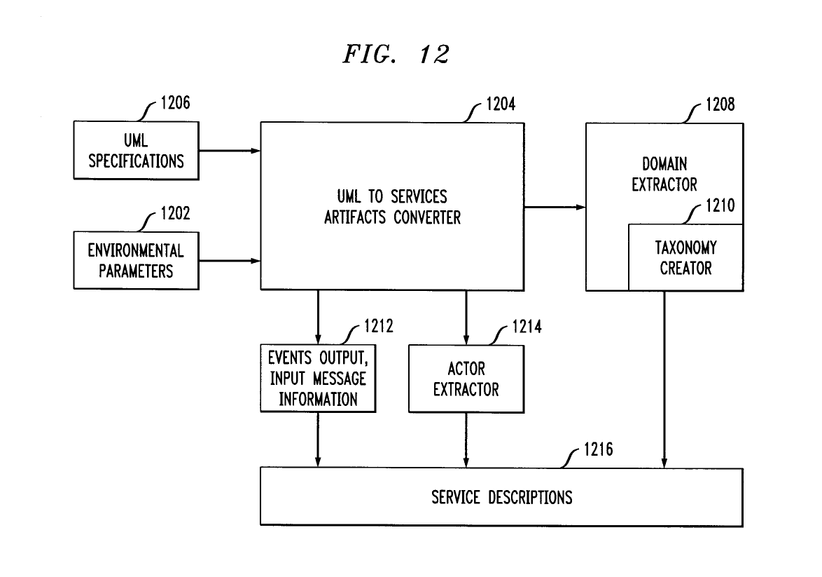

FIG. 12 presents an exemplary system block diagram. Block 1202 defines environmental parameters such as the actors, the domain information, and the like. Block 1204 takes as input the defined environmental parameters from block 1202, and the UML specifications 1206, and identifies, for each environmental parameter, a conversion rule to map the UML specifications. Domain extractor 1208, which may include taxonomy creator 1210, uses the artifacts from 1204 and provides suitable functionality to obtain the domain information. Block 1212 provides functionality to extract events, inputs, and outputs, while block 1214 provides functionality to extract actors. The extracted information from blocks 1208 (optionally with 1210), 1212, and 1214 is added to the service descriptions 1216.

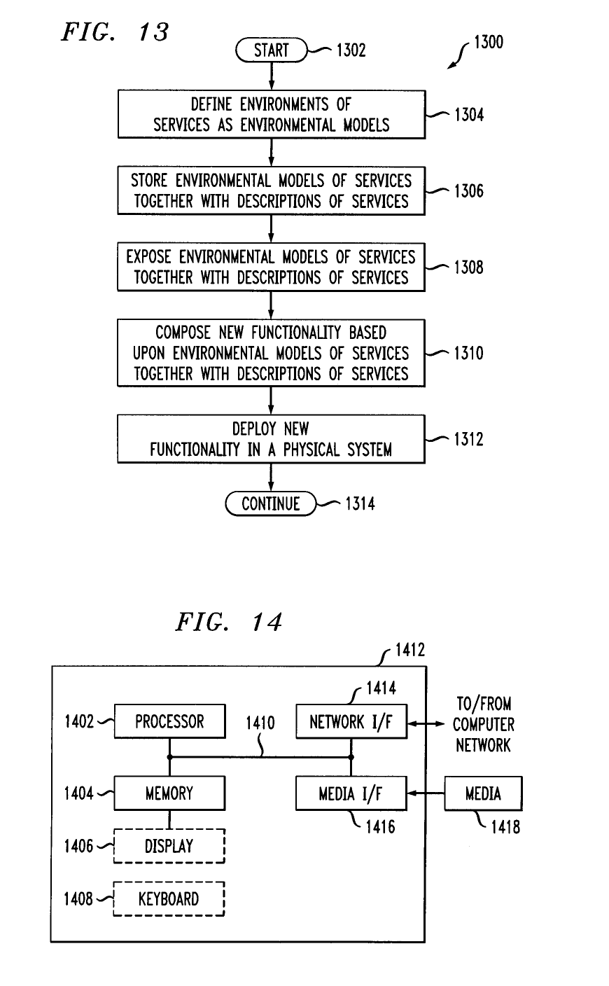

FIG. 13 shows a flow chart 1300 of exemplary method steps. Processing begins at 1302. In step 1304, for each of a plurality of existing services of a service-oriented architecture, define a corresponding environment (for example, with block 1202). In step 1306, store information representative of the defined corresponding environments together with descriptions of the existing services (store, for example, in block 1216; the environments can be mapped to the descriptions by block 1204). In step 1310, compose at least two of the existing services to provide new functionality, based upon the descriptions of the at least two existing services and the information representative of the defined corresponding environments for the at least two existing services.

In one or more embodiments, step 1304 includes extracting environmental artifacts from at least one design diagram (for example, 1206) representative of at least a portion of the service-oriented architecture, and step 1306 includes storing the information representative of the defined corresponding environments in environmental models. Optional but preferred step 1308 includes exposing the environmental models along with the descriptions of the existing services, to facilitate step 1310. Optional step 1312 includes deploying the new functionality in a physical system. Processing continues at step 1314.

The at least one design diagram could be expressed, for example, in unified modeling language (UML), as at 1206. The at least one design diagram could be, for example, a case diagram, a sequence diagram, a class diagram, and/or an enterprise model.

The environmental artifacts could represent at least one condition under which a given one of the existing services, to which a given one of the corresponding environments corresponds, can be invoked. In some instances, for at least some of the corresponding environments, the environmental artifacts include the domain of one of the existing services to which the given one of the corresponding environments corresponds. The “domain” includes the broader scope, that is, the taxonomy or categorization, of the service. The domain may be extracted, for example, with block 1208, with taxonomy creation by block 1210.

In some instances, for at least some of the corresponding environments, the environmental artifacts include at least one external input which directly results in invocation of one of the existing services to which a given one of the corresponding environments corresponds. Such external inputs could include, for example, under what conditions one of the existing services can be invoked, or a context in which one of the existing services can be invoked. Block 1212 can be employed for event extraction.

In one or more embodiments, for at least some of the corresponding environments, the environmental artifacts include at least one external factor (for example, interaction with an outside entity) which invokes one of the existing services to which a given one of the corresponding environments corresponds. Actors can be users or roles of user (while the actual user will depend on his or her role). Block 1214 can be employed for actor extraction.

### Exemplary System and Article of Manufacture Details

A variety of techniques, utilizing dedicated hardware, general purpose processors, firmware, software, or a combination of the foregoing may be employed to implement the present invention or components thereof. One or more embodiments of the invention, or elements thereof, can be implemented in the form of a computer product including a computer usable medium with computer usable program code for performing the method steps indicated. Furthermore, one or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. With reference to FIG. 14, such an implementation might employ for example, a processor 1402, a memory 1404, and an input/output interface formed, for example, by a display 1406 and a keyboard 1408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 1402, memory 1404, and input/output interface such as display 1406 and keyboard 1408 can be interconnected, for example, via bus 1410 as part of a data processing unit 1412. Suitable interconnections, for example via bus 1410, can also be provided to a network interface 1414, such as a network card, which can be provided to interface with a computer network, and to a media interface 1416, such as a diskette or CD-ROM drive, which can be provided to interface with media 1418.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

Furthermore, the invention can take the form of a computer program product accessible from a computer-usable or computer-readable medium (for example, media 1418) providing program code for use by or in connection with a computer or any instruction implementation system. For the purposes of this description, a computer usable or computer readable medium can be any apparatus for use by or in connection with the instruction implementation system, apparatus, or device. The medium can store program code to execute one or more method steps set forth herein.

The medium can be an electronic, magnetic, optical, electromagnetic, infrared, or semiconductor system (or apparatus or device) or a propagation medium. Examples of a tangible computer-readable recordable storage medium (as distinct from a propagation or transmission medium) include a semiconductor or solid-state memory (for example memory 1404), magnetic tape, a removable computer diskette (for example media 1418), a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor 1402 coupled directly or indirectly to memory elements 1404 through a system bus 1410. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 1408, displays 1406, pointing devices, and the like) can be coupled to the system either directly (such as via bus 1410) or through intervening I/O controllers (omitted for clarity).

Network adapters such as network interface 1414 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 1412 as shown in FIG. 14) running a server program. It will be understood that such a physical server may or may not include a display and keyboard.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the invention have been described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a tangible computer-readable recordable storage medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be implemented substantially concurrently, or the blocks may sometimes be implemented in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Furthermore, it should be noted that any of the methods described herein can include an additional step of providing a system comprising distinct software modules embodied on a tangible computer readable recordable storage medium; the modules can include, for example, any or all of the components shown in FIG. 12. The method steps can then be carried out using the distinct software modules and/or sub-modules of the system, as described above, executing on one or more hardware processors 1402. Further, a computer program product can include a tangible computer-readable recordable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising:
for each of a plurality of existing services of a service-oriented architecture, defining a corresponding environment;
storing information representative of the defined corresponding environments together with descriptions of the existing services; and
composing at least two of the existing services to provide new functionality, based upon the descriptions of the at least two existing services and the information representative of the defined corresponding environments for the at least two existing services.

2. The method of claim 1, wherein:
the defining of the corresponding environments comprises extracting environmental artifacts from at least one design diagram representative of at least a portion of the service-oriented architecture; and
the storing of the information representative of the defined corresponding environments comprises storing the information in environmental models;
further comprising facilitating the composing to provide the new functionality by exposing the environmental models along with the descriptions of the existing services.

3. The method of claim 2, wherein the at least one design diagram comprises a unified modeling language diagram.

4. The method of claim 2, wherein the at least one design diagram comprises at least one of a case diagram, a sequence diagram, a class diagram, and an enterprise model.

5. The method of claim 2, wherein the environmental artifacts comprise at least one condition under which a given one of the existing services, to which a given one of the corresponding environments corresponds, can be invoked.

6. The method of claim 2, wherein, for at least some of the corresponding environments, the environmental artifacts comprise a domain of one of the existing services to which a given one of the corresponding environments corresponds.

7. The method of claim 2, wherein, for at least some of the corresponding environments, the environmental artifacts comprise at least one external input which directly results in invocation of one of the existing services to which a given one of the corresponding environments corresponds.

8. The method of claim 7, wherein, for at least some of the corresponding environments, the at least one external input comprises an event indicating at least one of:
under what conditions the one of the existing services to which the given one of the corresponding environments corresponds can be invoked; and
a context in which the one of the existing services to which the given one of the corresponding environments corresponds can be invoked.

9. The method of claim 2, wherein, for at least some of the corresponding environments, the environmental artifacts comprise at least one external factor which invokes one of the existing services to which a given one of the corresponding environments corresponds.

10. The method of claim 9, wherein, for at least some of the corresponding environments, the at least one external factor comprises interaction with an outside entity.

11. The method of claim 2, further comprising deploying the new functionality in a physical system.

12. The method of claim 1, further comprising providing a system, wherein the system comprises distinct software modules, each of the distinct software modules being embodied on a tangible computer-readable recordable storage medium, and wherein the distinct software modules comprise an environmental parameter definition module, an environmental parameter to service specification mapper module, and a service descriptions module;
wherein:
the defining of the corresponding environment is carried out by the environmental parameter definition module executing on at least one hardware processor;
the information representative of the defined corresponding environments together with descriptions of the existing services is stored in the service descriptions module, with the environments mapped to the descriptions by the environmental parameter to service specification mapper module executing on the at least one hardware processor.

13. A computer program product comprising a tangible computer readable recordable storage medium including computer usable program code, the computer program product including:
computer usable program code for, for each of a plurality of existing services of a service-oriented architecture, defining a corresponding environment;
computer usable program code for storing information representative of the defined corresponding environments together with descriptions of the existing services; and
computer usable program code for composing at least two of the existing services to provide new functionality, based upon the descriptions of the at least two existing services and the information representative of the defined corresponding environments for the at least two existing services.

14. The computer program product of claim 13, wherein:
the computer usable program code for defining of the corresponding environments comprises computer usable program code for extracting environmental artifacts from at least one design diagram representative of at least a portion of the service-oriented architecture; and
the computer usable program code for storing of the information representative of the defined corresponding environments comprises computer usable program code for storing the information in environmental models;
further comprising computer usable program code for facilitating the composing to provide the new functionality by exposing the environmental models along with the descriptions of the existing services.

15. The computer program product of claim 14, wherein the at least one design diagram comprises a unified modeling language diagram.

16. The computer program product of claim 13, further comprising distinct software modules, each of the distinct software modules being embodied on the tangible computer-readable recordable storage medium, the distinct software modules comprising an environmental parameter definition module, an environmental parameter to service specification mapper module, and a service descriptions module;
wherein:
the environmental parameter definition module comprises the computer usable program code for defining of the corresponding environments; and
the environmental parameter to service specification mapper module and the service descriptions module comprise the computer usable program code for storing information representative of the defined corresponding environments together with descriptions of the existing services.

17. An apparatus comprising:
a memory; and
at least one processor, coupled to the memory, and operative to:
for each of a plurality of existing services of a service-oriented architecture, define a corresponding environment;
store information representative of the defined corresponding environments together with descriptions of the existing services; and
compose at least two of the existing services to provide new functionality, based upon the descriptions of the at least two existing services and the information representative of the defined corresponding environments for the at least two existing services.

18. The apparatus of claim 17, wherein:
the defining of the corresponding environments comprises the at least one processor extracting environmental artifacts from at least one design diagram representative of at least a portion of the service-oriented architecture; and
the storing of the information representative of the defined corresponding environments comprises the at least one processor storing the information in environmental models in the memory;
further comprising the at least one processor facilitating the composing to provide the new functionality by exposing the environmental models along with the descriptions of the existing services.

19. The apparatus of claim 17, further comprising a tangible computer-readable recordable storage medium having distinct software modules embodied thereon, wherein the distinct software modules comprise an environmental parameter definition module, an environmental parameter to service specification mapper module, and a service descriptions module;
wherein:
the defining of the corresponding environment is carried out by the environmental parameter definition module executing on the at least one processor;
the information representative of the defined corresponding environments together with descriptions of the existing services is stored in the service descriptions module, with the environments mapped to the descriptions by the environmental parameter to service specification mapper module executing on the at least one processor.

20. An apparatus comprising:
means for, for each of a plurality of existing services of a service-oriented architecture, defining a corresponding environment;
means for storing information representative of the defined corresponding environments together with descriptions of the existing services; and
means for composing at least two of the existing services to provide new functionality, based upon the descriptions of the at least two existing services and the information representative of the defined corresponding environments for the at least two existing services.
